(19) United States
(12) Patent Application Publication
(10) Pub. No.: US 2026/0111537 A1
(43) Pub. Date: Apr. 23, 2026

(54) MITIGATING A COPY-PASTE ATTACK USING AN ISOLATED COMPUTING ENVIRONMENT

(71) Applicant: Red Hat, Inc., Raleigh, NC (US)

(72) Inventors: Tomas Meszaros, Brno (CZ); Paolo Antinori, Milan (IT)

(21) Appl. No.: 18/923,817

(22) Filed: Oct. 23, 2024

(51) Int. Cl. G06F 21/53; G06F 21/54

(52) U.S. Cl. CPC G06F 21/53; G06F 21/54

(57) ABSTRACT

A paste command to transfer data to a user interface (UI) text field of a first command line interface (CLI) is detected. The data is inhibited from being transferred to the UI text field. The data is caused to be entered as a command to a second CLI of an isolated computing environment. Information generated in response to the data being entered as the command to the second CLI is output.

### BACKGROUND

It is relatively common for a computer user to copy-paste content found on an external source, such as a website, into a text field of a command line interface (CLI) of a computing device in order to eliminate the need for the user to accurately type a complex command line instruction into the text field.

### SUMMARY

The present disclosure is generally directed to mechanisms for mitigating a copy-paste attack using an isolated computing environment.

In one implementation, a method is provided. The method includes detecting, by a computing device, a paste command to transfer data to a user interface (UI) text field of a first command line interface (CLI). The method further includes inhibiting, by the computing device, the data from being transferred to the UI text field. The method further includes causing, by the computing device, the data to be entered as a command to a second CLI of an isolated computing environment. The method further includes outputting, to a display device, information generated in response to the data being entered as the command to the second CLI.

In another implementation, a computing system is provided. The computing system includes one or more computing devices operable to detect a paste command to transfer data to a user interface (UI) text field of a first command line interface (CLI). The one or more computing devices are further operable to inhibit the data from being transferred to the UI text field. The one or more computing devices are further operable to cause the data to be entered as a command to a second CLI of an isolated computing environment. The one or more computing devices are further operable to output information generated in response to the data being entered as the command to the second CLI.

In another implementation, a non-transitory computer-readable storage medium is provided. The non-transitory computer-readable storage medium includes executable instructions to cause one or more computing devices to detect a paste command to transfer data to a user interface (UI) text field of a first command line interface (CLI). The instructions further cause the one or more computing devices to inhibit the data from being transferred to the UI text field. The instructions further cause the one or more computing devices to cause the data to be entered as a command to a second CLI of an isolated computing environment. The instructions further cause the one or more computing devices to output information generated in response to the data being entered as the command to the second CLI.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which mechanisms for mitigating a copy-paste attack using an isolated computing environment may be practiced;

FIGS. 2A-2B are a sequence flow diagram illustrating actions taken and messages exchanged between certain components illustrated in FIG. 1 for according to one implementation;

FIG. 3 is a flowchart diagram of a method for mitigating a copy-paste attack using an isolated computing environment according to some implementations;

FIG. 4 is a simplified block diagram of the environment illustrated in FIG. 1 according to one implementation; and

FIG. 5 is a block diagram of a computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A copy-paste attack on a command line terminal (e.g., a command line interface) is a type of cyberattack in which malicious code is secretly added to the content that a user copies from a webpage or other source. The malicious code is then executed when the user pastes this content into the command line terminal, which may result in a serious security breach especially if the user pasted the malicious code inside a privileged command line terminal environment. For example, a user may visit a webpage that appears to contain harmless command-line instructions and decide to copy these instructions to use the instructions in their terminal. The webpage may contain malicious code hidden within the text that the user is copying, which can be accomplished using various Javascript or HTML/CSS techniques. In some instances, the malicious code is not directly visible on the webpage, but gets included when the text is copied and stored in the clipboard buffer (e.g., temporary storage area).

When the user pastes the copied text into the command line terminal, which interprets the pasted text as commands, the malicious code gets executed. This can be potentially catastrophic, especially when the command is executed by a user with elevated privileges (like root) and may allow, by way of non-limiting example, an attacker to take control of the system (for example via an installed backdoor) and could attack the infrastructure supply chain, user data, etc. Alternatively or additionally, by way of non-limiting example, the command may delete information, such as files or folders, that the user does not intend to delete, or may cause the encryption of information with an encryption key unknown to the user that prevents the user from decrypting the information.

Advantageously, the examples set forth below include systems and methods that can mitigate the above described attack by listening for paste events from the clipboard buffer in the terminal, intercepting such events, taking the pasted string, and executing it in an isolated computing environment. In one implementation, the isolated computing environment may comprise a container. The container image from which the container is initiated can be built and ready to be used to spawn the container on-demand when the event listener catches the paste event. Alternatively, the container may continuously run and be provided such pasted strings during such copy-paste actions.

An advantage of pre-building the container image is that the container image is ready to be used immediately, and the user does not need to wait for image building. Additionally or alternatively, examples set forth below also include building the container image in response to the detected paste event. An advantage of building the container in response to a paste event is that hardened containers can be tailored to dynamic security levels based on the contents of the string copied by the user, or some other suitable criterion. The container can be launched with an attached command line terminal (e.g., shell) and may log activities to the mounted volume on the host, so the user, or the container, can identify if the command was malicious or not.

After the execution of the command finishes, the user may be given an option to either proceed with the execution of the pasted string in the command line terminal or discard the pasted string. The mechanisms described herein provide an automated and efficient way for a user to test what the unknown and potentially hostile command copied from the website does in an isolated computing environment to thereby eliminate the possibility that a hidden command might otherwise disrupt or render inoperable an entire computing environment.

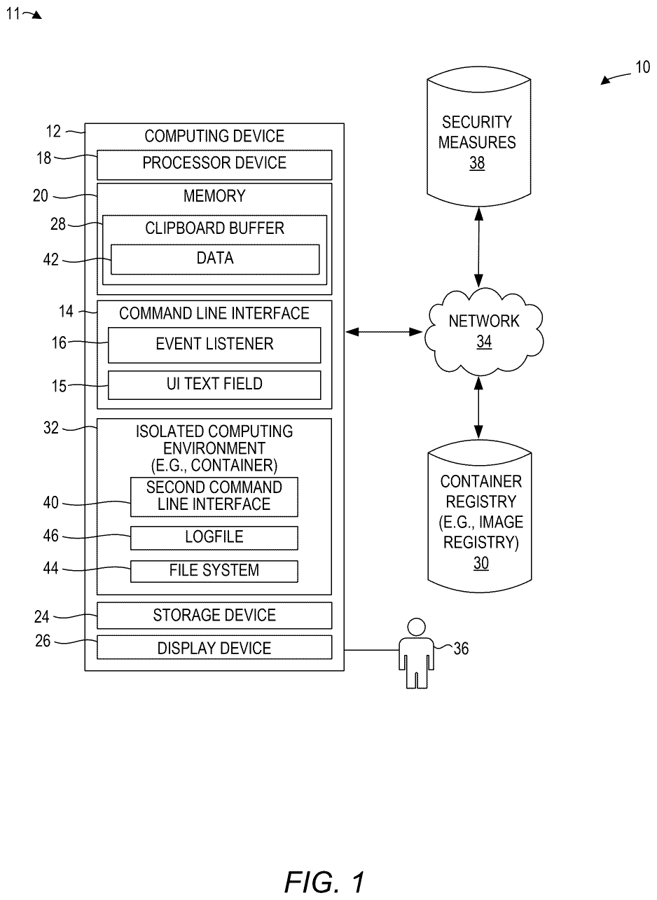

FIG. 1 is a block diagram of an environment in which examples disclosed herein may be practiced. A computing environment 10 includes a computing system 11 that includes one or more computing devices 12. The computing device 12 can include a command line interface (CLI) 14. The CLI 14 can include a text-based user interface (UI) configured to run programs, manage computer files, or otherwise interact with a computing system (e.g. computing device 12) or servers (e.g., isolated computing environment 32, etc.). In particular, a user may enter a command into a UI text field 15 and then submit the command to the CLI 14, such as, for example, by pressing an enter key or otherwise requesting the CLI 14 to act upon the command. The CLI 14 can include an event listener 16. The CLI 14 may comprise or be part of an application, such as a shell, a terminal, a console, or the like via which a user 36 can enter commands, such as Linux commands in the case where the computing device 12 runs a Linux operating system. For example, in the context of a Linux operating system, the CLI 14 may comprise a Linux terminal application, and a user may enter the command “mkdir testdir” into a UI text field of the Linux terminal application to create a new directory called testdir.

The event listener 16 can be invoked upon the occurrence of an event, such as a paste command in the CLI 14. Event listeners enable computing systems to respond to a wide range of user interactions, such as clicks, mouse movements, keyboard inputs (e.g., paste commands, etc.). For instance, the event listener 16 can include a function (e.g., computing instructions, JavaScript, etc.) that can be called by a server, command line interface plug-in, or another computing process. The event listener 16 can wait for an event (e.g., a listen event) to occur and, in response to the event, take an action.

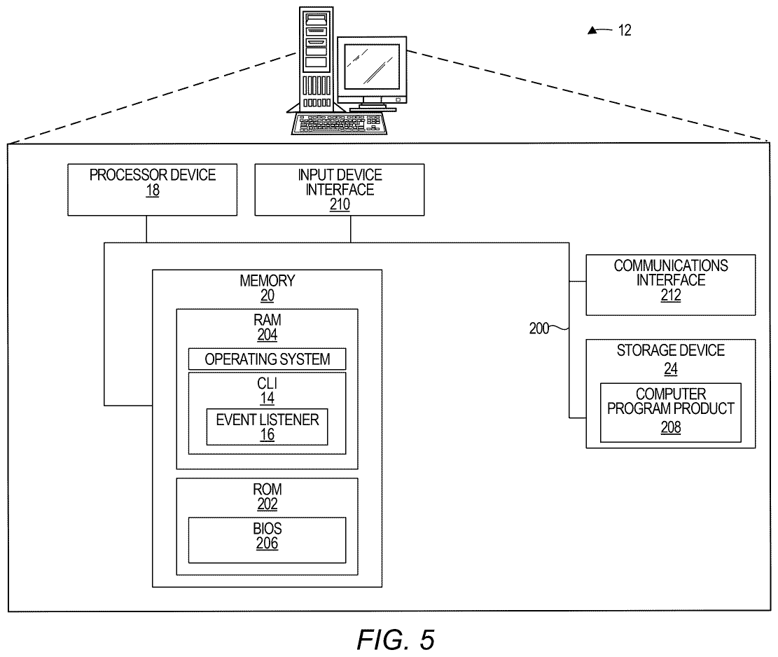

The computing device 12 may comprise any computing or electronic device capable of including firmware, hardware, and/or executing software instructions to implement the functionality described herein, such as a computer server, a desktop computing device, a laptop computing device, a smartphone, a computing tablet, or the like. Each computing device 12 of a computing environment 10 can include one or more processor devices 18, memories 20, storage devices 24, or display devices 26. The computing device 12 may include a clipboard buffer 28 within the memory 20. The clipboard buffer 28 can be configured to provide short-term (e.g., temporary) storage and facilitate the transfer of data within and between application programs running on the computing device 12, such as via, for example, copy and paste commands to transfer the data from a website to the UI text field 15 of the CLI 14. The computing device 12 can execute one or more processes (e.g., via the processor device 18) to interact with a container registry 30, security measures 38, and an isolated computing environment 32 over one or more networks 34. Additional example implementation details for a computing device 12 are provided below with respect to FIG. 5.

The network 34 may be a private network (e.g., a local area network (LAN), a wide area network (WAN), intranet, or other similar private networks), a public network (e.g., the Internet), or any combination thereof.

As will be discussed in greater detail herein, the examples utilize the isolated computing environment 32 to ensure that data that a user 36 attempts to paste into the CLI 14 does not contain nefarious instructions that, when submitted as a command, causes unexpected behavior. In particular, prior to permitting the data to be pasted to the UI text field 15 of the CLI 14 in what may be referred to herein as a primary computing environment, the command is first submitted in the isolated computing environment 32 so that, if the command implements nefarious functionality, such functionality is limited to the isolated computing environment 32 and does not impact the primary computing environment. The term “isolated computing environment” refers to a computing environment that is isolated from the computing environment in which the user 36 desires to paste the command into the CLI 14. By way of non-limiting examples, examples of an isolated computing environment 32 include a container, a virtual machine (VM), a separate dedicated computing device, or the like. A primary computing environment may comprise, for example, the host computing environment of the computing device 12.

The container registry 30 (e.g., image registry) can include a repository (or a plurality of repositories) configured to store and access container images. The phrase “container” as used herein refers to a running process that is isolated from other processes via namespaces and cgroups, or equivalent isolation techniques. A container is executed (e.g., initiated or instantiated) from a container image. A container image is a static package of software comprising one or more layers, the layers including everything needed to run an application (i.e., as a container) that corresponds to the container image, including, for example, one or more of executable runtime code, system tools, system libraries, and configuration settings. A Docker® image is an example of a container image. A container image typically includes one or more file directories that include all executables, other than the host operating system kernel, necessary for the container to run. The life-cycle of a container is typically managed by a container runtime, sometimes referred to as a container engine, such as, by way of non-limiting example, runC, crun, containerd, Docker®, Windows® Containers, and the like.

In some instances, the container registry 30 can include pre-built container images. In some instances, the container registry 30 can store container images built on-demand by computing processes. While examples herein describe an implementation using the container registry 30 and container images, the present disclosure is not limited to such embodiments and may be implemented using any type of isolated computing environment including, but not limited to virtual machines (VMs), servers, or the like.

The security measures 38 (e.g., hardening measures) can include a repository of hardening configurations for increasing the security posture of the isolated computing environment 32. Example hardening configurations can include image definitions, variables, security modules, etc. By way of example, a security measure 38 can include using sandboxing technology to limit the visibility of the isolated computing environment 32. One example of such sandboxing technology is gVisor sandboxing technology available at gVisor. dev. gVisor intercepts application system calls made by a container and acts as the guest kernel, without a need for translation through virtualized hardware.

In another example, security measures 38 can include a Docker® cap-drop option, or similar option available in other container technologies, to remove all Linux kernel capabilities of the container. In some instances, the security measures 38 can be included in pre-built container images stored in the container registry 30. In some instances, the security measures 38 can be accessed to modify or build container images in real-time. In some instances, a particular security measure 38 may be a run-time parameter.

The isolated computing environment 32 can be, comprise, be comprised by, or otherwise include any computing environment isolated from the computing device 12 on the network 34. While illustrated in FIG. 1 as being implemented in the computing device 12, in other implementations, the isolated computing environment 32 may be executed on another computing device.

For example, the isolated computing environment 32 can be hosted on any type of computing node, which may be a virtualized or bare metal computing device such as a server computer, a desktop computer, and the like. In one example, the computing device 12 may be the same computing machine that hosts the isolated computing environment 32.

The isolated computing environment 32 can include an second CLI 40. The second CLI 40 can include similar properties as the CLI 14.

The isolated computing environment 32 may comprise a container initiated from a container image obtained from the container registry 30. The container may include one or more security measures 38 (e.g., hardening measures).

By way of example, the event listener 16 may be configured to listen for paste events (e.g., a ctrl-V command to transfer data from the clipboard buffer 28 to the UI text field 15 of the CLI 14). In response to the paste event, the event listener 16 inhibits the data from being transferred to the UI text field 15 and may cause the isolated computing environment 32 to be initiated from a container image. The event listener 16 provides the data encompassed by the ctrl-V command to the isolated computing environment 32 for analysis and submission to the second CLI 40. The event listener 16 may provide the data to the isolated computing environment 32 via any suitable inter-process communication mechanism, such as, by way of non-limiting example, a runtime variable, by storing the data in a known location, or the like.

In some instances, the isolated computing environment 32 can include similar configurations to the computing device 12. For instance, there may be one or more instances of parity between the isolated computing environment 32 and the computing device 12. Parity can include consistency across runtime, environment variables, configuration files, and the like.

With this background, an example of mitigating a copy-paste attack using an isolated computing environment will be described. Assume that the user 36 accesses a website that illustrates a command than can be entered into a terminal application, such as the CLI 14 (e.g., first command line interface), to accomplish some desired task. For example, the command may purport to merge two files together, copy data from one location to another, configure a computing device in a certain manner, or the like. The user 36, rather than type the command into the UI text field 15 of the CLI 14, determines it would be preferable to copy the command and paste the command into the the UI text field 15 to eliminate the possibility of a typographic error.

The user 36 highlights the command and selects a copy function, such as by right-clicking a mouse and selecting a copy function, or by pressing the keys ctrl-C concurrently. The data selected by the copy function is copied into the clipboard buffer 28 as data 42. Unbeknownst to the user 36, the website contained nefarious code that actually resulted in data being copied that was not visible to the user 36 such that a different command was copied than the command visible to the user 36.

The user 36 moves a cursor to the UI text field 15 such that the CLI 14 becomes the active window. The user 36 selects a paste function to cause the data 42 to be pasted (e.g., copied) to the UI text field 15 from the clipboard buffer 28. The event listener 16 has registered to receive paste events for the UI text field 15, and thus detects the paste command to transfer the data 42 to the UI text field 15. The event listener 16 inhibits the data 42 from being transferred to the UI text field 15. It is noted that a ctrl-V command is an example of a paste command, but the examples disclosed herein relate to any paste command that causes a paste event, such as, by way of non-limiting example, a drag-and-drop of highlighted text from one location to another location in a user interface, or any other sequence of actions that causes the generation of a paste event.

The event listener 16 causes the data 42 to be entered as a command on the second CLI 40 (e.g., second command line interface) of the isolated computing environment 32). In particular, the event listener 16 causes the initiation of the isolated computing environment 32. In this example, the isolated computing environment 32 comprises a container, and the event listener 16 may issue a suitable command to cause the isolated computing environment 32 to initiate from a container image. In other implementations, the event listener 16 may cause the initiation of a virtual machine (VM), or other suitable isolated computing environment.

As discussed previously, the isolated computing environment 32 may be “hardened” in that anything that occurs in the isolated computing environment 32 is limited to the isolated computing environment 32. For example, the isolated computing environment 32 may be mounted with a file system 44 that is read-only such that any attempt to alter the file system will be rejected. The isolated computing environment 32 may be initiated with sandboxing technology that eliminates an ability for anything that occurs within the isolated computing environment 32 from impacting anything outside the isolated computing environment 32. The isolated computing environment 32 may be initiated with capability limited options, such as a Docker® cap-drop option, that limits access to kernel capabilities.

The event listener 16 causes the data 42 to be provided to the isolated computing environment 32. The event listener 16 may use any suitable mechanism for transferring the data 42 to the isolated computing environment 32. For example, the event listener 16 may send the data 42 to the isolated computing environment 32 via a network call, may provide the data 42 to the isolated computing environment 32 as a runtime variable, or may store the data 42 to a predetermined location known to the isolated computing environment 32.

The isolated computing environment 32 obtains the data 42. The isolated computing environment 32 enters the data 42, including the characters visible to the user 36 and any that were not visible into the second CLI 40 such that the second CLI 40 attempts to process the data 42 as a command. Any actions taken by the second CLI 40 in response to processing the data 42 as a command are logged to a logfile 46. The logfile 46 may identify the data 42 and what occurred when processing the data 42. For example, the logfile 46 may indicate that the data 42 was an “rm −r” command that attempted to remove one or more directories of the file system 44. The logfile 46 may also indicate that the attempt to remove the one or more directories was unsuccessful because the directories of the file system 44 were read-only. In another example, the logfile 46 may indicate that the data 42 was a command that attempts to merge two files together, and indicates that the command was not successful because the two files do not exist in the file system 44 and/or because the file system 44 is read-only.

The logfile 46 can be made accessible from the isolated computing environment 32. For instance, the container image (e.g., for the isolated computing environment 32) can be configured to expose the logfile 46 from the container to the CLI 14, the storage device 24, or the display device 26 to display to the user 36. In some implementations, the second CLI 40 may send the logfile 46 via a network call, or other inter-process communication technique. In other implementations, the second CLI 40 may store the contents of the logfile 46 in a location known to and accessible by the computing device 12.

The event listener 16 may generate information based on the contents of the logfile 46 and present the information on the display device 26. The information may include, by way of non-limiting example, outputting a prompt to the display device 26, wherein the prompt includes a first option to paste the data 42 to the UI text field 15 or a second option to not paste the data 42 to the UI text field 15. The user 36 may view the prompt and select the first option. The event listener 16 receives user input selecting the first option and, in response to the user input, executes the paste command to transfer the data 42 to the UI text field 15. The user 36 may then cause the data to be processed as a command by the CLI 14 such as by pressing an enter key or the like.

Alternatively, the user 36 may view the prompt and select the second option. The event listener 16 receives user input selecting the second option, and in response to the user input, discards the data 42 and does not execute the paste command.

It is noted that, because the event listener 16, in this example, is a component of the CLI 14, functionality implemented by the event listener 16 may be attributed to the CLI 14 generally. Moreover, because the CLI 14 is a component of the computing system 11, functionality implemented by the CLI 14 may be attributed to the computing system 11 generally, or to one or more computing devices 12 generally. Additionally, in examples where the CLI 14 comprises software instructions that program a processor device 18 of a computing device 12 to carry out functionality discussed herein, functionality implemented by the CLI 14 may be attributed herein to one or more processor devices 18.

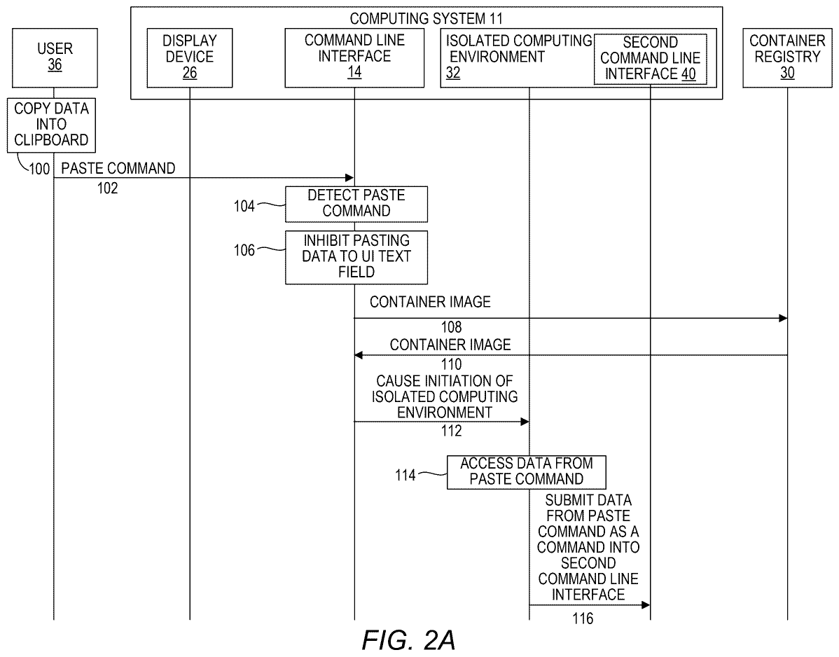

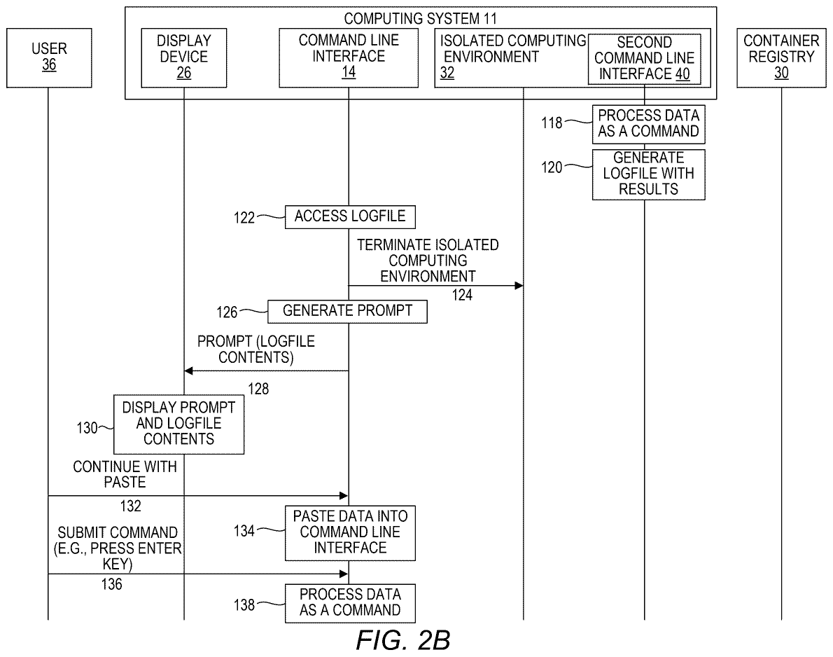

FIGS. 2A-2B are a sequence flow diagram illustrating actions taken and messages exchanged between certain components illustrated in FIG. 1 for according to one implementation. Although FIGS. 2A-2B depict steps in a particular order for purposes of illustration and discussion, the present disclosure is not limited to the particular illustrated order or arrangement. For example, various steps can be omitted, added, rearranged, or otherwise modified without deviating from the scope of the present disclosure.

Referring first to FIG. 2A, the user 36 copies data to the clipboard buffer 28 (FIG. 2A, step 100). For example, the user 36 may highlight text on a website that purports to be a command that can be entered into a command line interface to perform some task. The user 36 selects a copy action, copying the data 42 to the clipboard buffer 28. In some instances, the data can include additional computing instructions unknown or not visible to the user 36. For instance, the user 36 can copy what appears to be a few characters of the data 42; however, additional nefarious computing instructions not visible to the user may also be stored in the clipboard buffer 28.

The user 36 attempts to paste the data 42 into the UI text field 15 of the CLI 14 such as, by way of non-limiting example, initiating a ctrl-V key sequence (FIG. 2A, step 102). In an alternative sequence of actions, the user 36 may highlight the data 42 on one window and drag-and-drop the highlighted text onto the UI text field 15, causing both a copy command and a paste command in one action. The CLI 14 detects the paste command indicating the intent of the user 36 to paste or transfer the data 42 stored in the clipboard buffer 28 to the CLI 14 (FIG. 2A, step 104).

The CLI 14 inhibits the data from being transferred to the UI text field 15 (FIG. 2A, step 106). The CLI 14 pulls a container image from the container registry 30 (FIG. 12A, steps 108, 110). The CLI 14 initiates the container image as the isolated computing environment 32 on a computing device 12 of the computing system 11 (FIG. 2A, step 112). The isolated computing environment 32 includes the second CLI 40, and may contain additional processes for hardening the isolated computing environment 32 such that any command processed by the second CLI 40 cannot impact the environment of the computing device 12 that is external to the isolated computing environment 32.

For example, the security measures 38 can be applied to the container image to enable, disable, or configure capabilities or access levels for the container (e.g., read-only, Docker® cap-drop option, sandbox technology, or the like).

As discussed above, the isolated computing environment 32 may, in other implementations, comprise a physical server that is separate from the computing device 12, or a virtual machine (VM) that is initiated on the computing device 12 or another computing device.

In some implementations, the CLI 14 may invoke a preliminary security analysis of the data 42 stored in the clipboard buffer 28. For instance, the CLI 14 can call (e.g., via webhooks, API calls, etc.) one or more security tools to analyze the data 42 to detect one or more threat characteristics. Example security tools can include static code analysis tools, vulnerability analysis tools, malware scanning, etc. The threat characteristics can indicate a level or type of security threat associated with the data. For instance, the security tools can determine whether the data 42 may be associated with a type of malicious software. Based on the threat characteristics, the event listener 16 can cause security measures 38 to be included (e.g., modified, etc.) in the hardened container image for the isolated computing environment 32.

By way of example, security analysis tools may analyze the data and determine the data includes threat characteristics associated with a rootkit. Rootkits are a type of malware designed to provide privileged access (root access) to a computer. Once a rootkit has been installed, the controller can remotely execute files, change system configurations, alter software (particularly security software), or access secured information. In response to the threat characteristics associated with a rootkit, security measures 38 inhibiting communications (e.g., to other files) from the container or limiting access to resources (e.g., host kernel, etc.) external from the container may be included in the hardened container image.

The CLI 14 causes the data 42 to be provided to the isolated computing environment 32. By way of non-limiting example, the CLI 14 can execute a pipe command to redirect the data 42 (e.g., from the clipboard buffer 28) to the isolated computing environment 32 and thereby temporarily inhibit the data 42 from being transferred to the UI text field 15. For instance, the second CLI 40 can receive the data 42 as command line instructions. While the example described herein refers to the use of a pipe command to inhibit the data 42 from being pasted to the UI text box 15, it will be appreciated that other techniques may be used to temporarily inhibit the data 42 from being pasted to the UI text box 15. For example, the event listener 16, subsequent to being invoked in response to the paste command, may return a value that indicates the paste command is to be terminated.

The isolated computing environment 32 obtains the data 42 and submits the data as a command to the second CLI 40 (FIG. 2A, steps 114, 116). Referring now to FIG. 2B, the second CLI 40 processes the data 42 as a command within the isolated computing environment 32 (FIG. 2B, step 118).

The second CLI 40 generates one or more logfiles 46 that identifies the results of processing the data 42 (FIG. 2B, step 120).

The logfile 46 can depict the behavior of the data (e.g., data 42) copied by the user 36. For instance, the logfile 46 can depict log information including application container logs, system container logs, and/or network logs.

Application container logs can include logs indicating the functions/processes of the data 42 itself. Application container logs can include but are not limited to logfiles with time stamps of specific functions (e.g., messages, calls, etc.) resulting from processing the data 42. System container logs can indicate the performance of the isolated computing environment 32 in response to processing the data 42. Example system container logs can include, but are not limited to, build logs (e.g., generated during container image builds), service logs (e.g., from accessed or attempted accessed services), system level logs (e.g., from the container engine), etc. Network logs can include, but are not limited to, logfiles indicating requests or attempted requests (e.g., messages, communications, etc.) from the isolated computing environment 32, server access logs (e.g., indicating attempts to access the server, etc.), client request logs, etc.

The CLI 14 accesses the logfile 46 (FIG. 2B, step 122). In some implementations, the second CLI 40 may store the logfile 46 in a known location and the CLI 14 periodically polls the known location to determine that the logfile 46 has been created. The CLI 14 causes the isolated computing environment 32 to be terminated (FIG. 2B, step 124). The CLI 14 generates a prompt that may include information from the logfile 46, and options to either proceed with the paste command or not to proceed with the paste command (FIG. 2B, step 126). The CLI 14 sends the prompt to the display device 26 (FIG. 2B, step 128). The display device 26 presents the prompt to the user 36 (FIG. 2B, step 130). In this example, the user 36 reviews the logfile contents and decides that the data 42 was not a nefarious command and is the command that the website from which the data 42 was copied purported the command to be. The user 36 selects an option to continue with the paste command (FIG. 2B, step 132).

The CLI 14 causes the data 42 to be pasted into the UI text field 15 (FIG. 2B, step 134). In some implementations, the event listener 16 may return a value to the invoking application that indicates that the paste event is permitted to continue such that the data 42 is pasted into the UI text field 15. The user 36 then causes the command to be submitted to the CLI 14 for processing, such as by pressing an enter key, or the like (FIG. 2B, step 136).

In an alternative example, the user 36 reviews the logfile contents and decides that the data 42 is a nefarious command and is not the command that the website from which the data 42 was copied purported the command to be. The user 36 selects an option to not to proceed with the paste command. The CLI 14 causes the data 42 to be discarded and not pasted into the UI text field 15. In some implementations, the event listener 16 may return a value to the invoking application that indicates that the paste event is not to proceed.

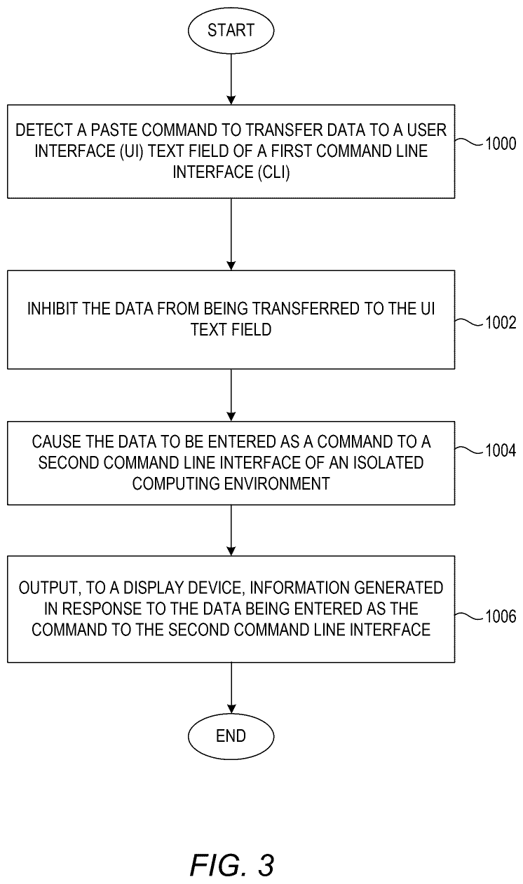

FIG. 3 is a flowchart of a method for mitigating a copy-paste attack using an isolated computing environment according to one implementation. Although FIG. 3 depicts steps in a particular order for purposes of illustration and discussion, the present disclosure is not limited to the particularly illustrated order or arrangement. For example, various steps can be omitted, added, rearranged, or otherwise modified without deviating from the scope of the present disclosure.

The computing system 11 detects a paste command to transfer the data 42 to the UI text field 15 of the CLI 14 (e.g., first command line interface) (FIG. 3, block 1000). The computing system 11 inhibits the data 42 from being transferred to the UI text field 15 (FIG. 3, block 1002). The computing system 11 causes the data 42 to be entered as an executable command on the second CLI 40 of the isolated computing environment 32 (FIG. 3, block 1004). The computing system 11 outputs, to the display device 26, information generated in response to the data 42 being entered as the executable command to the second CLI 40 (FIG. 3, block 1006).

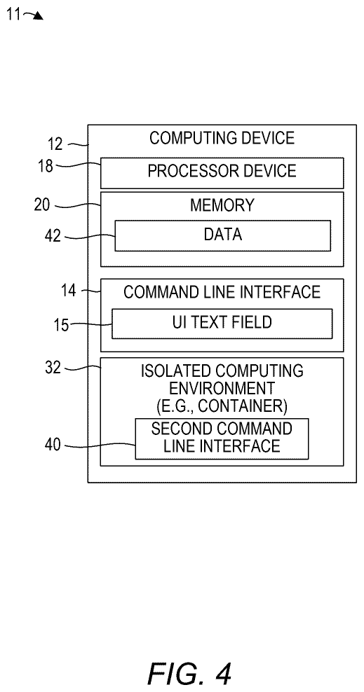

FIG. 4 is a simplified block diagram of the environment illustrated in FIG. 1 according to one implementation. The computing system 11 includes the one or more computing devices 12. The one or more computing devices 12 are to detect the paste command to transfer the data 42 to the UI text field 15 of the CLI 14. The one or more computing devices 12 inhibit the data 42 from being transferred to the UI text field 15. The one or more computing devices 12 cause the data 42 to be entered as a command to the second CLI 40 of the isolated computing environment 32. The one or more computing devices 12 output information generated in response to the data 42 being entered as the executable command to the second CLI 40.

FIG. 5 is a block diagram of the computing device 12 suitable for implementing examples according to one example. The computing device 12 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 12 includes the processor device 18, the system memory 20, and a system bus 200. The system bus 200 provides an interface for system components including, but not limited to, the system memory 20 and the processor device 18. The processor device 18 can be any commercially available or proprietary processor.

The system bus 200 may be any of several types of bus structures that may further interconnect to a memory bus (with or without a memory controller), a peripheral bus, and/or a local bus using any of a variety of commercially available bus architectures. The system memory 20 may include non-volatile memory 202 (e.g., read-only memory (ROM), erasable programmable read-only memory (EPROM), electrically erasable programmable read-only memory (EEPROM), etc.), and volatile memory 204 (e.g., random-access memory (RAM)). A basic input/output system (BIOS) 206 may be stored in the non-volatile memory 202 and can include the basic routines that help to transfer information between elements within the computing device 12. The volatile memory 204 may also include a high-speed RAM, such as static RAM, for caching data.

The computing device 12 may further include or be coupled to a non-transitory computer-readable storage medium such as the storage device 24, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 24 and other drives associated with computer-readable media and computer-usable media may provide non-volatile storage of data, data structures, computer-executable instructions, and the like.

A number of modules can be stored in the storage device 24 and in the volatile memory 204, including an operating system and one or more program modules, such as the CLI 14 and the event listener 16, which may implement the functionality described herein in whole or in part. All or a portion of the examples may be implemented as a computer program product 208 stored on a transitory or non-transitory computer-usable or computer-readable storage medium, such as the storage device 24, which includes complex programming instructions, such as complex computer-readable program code, to cause the processor device 18 to carry out the steps described herein. Thus, the computer-readable program code can comprise software instructions for implementing the functionality of the examples described herein when executed on the processor device 18. The processor device 18, in conjunction with the CLI 14 in the volatile memory 204, may serve as a controller, or control system, for the computing device 12 that is to implement the functionality described herein.

An operator, such as the user 36 (not illustrated), may also be able to enter one or more configuration commands through a keyboard (not illustrated), a pointing device such as a mouse (not illustrated), or a touch-sensitive surface such as a display device (not illustrated). Such input devices may be connected to the processor device 18 through an input device interface 210 that is coupled to the system bus 200 but can be connected by other interfaces such as a parallel port, an Institute of Electrical and Electronic Engineers (IEEE) 1394 serial port, a Universal Serial Bus (USB) port, an IR interface, and the like. The computing device 12 may also include a communications interface 212, such as an Ethernet transceiver and/or a Wi-Fi® transceiver, or the like, suitable for communicating with the network 34 as appropriate or desired.

Individuals will recognize improvements and modifications to the preferred examples of the disclosure. All such improvements and modifications are considered within the scope of the concepts disclosed herein and the claims that follow.

What is claimed is:

1. A method comprising:
detecting, by a computing device, a paste command to transfer data to a user interface (UI) text field of a first command line interface (CLI);
inhibiting, by the computing device, the data from being transferred to the UI text field;
causing, by the computing device, the data to be entered as a command to a second CLI of an isolated computing environment; and
outputting, to a display device, information generated in response to the data being entered as the command to the second CLI.

2. The method of claim 1, wherein detecting the paste command comprises detecting a request to transfer the data from a clipboard, the clipboard comprising a temporary storage area for copying and pasting the data between applications.

3. The method of claim 1, further comprising:
subsequent to inhibiting the data from being transferred to the UI text field, initiating the isolated computing environment.

4. The method of claim 3, wherein the isolated computing environment comprises a container.

5. The method of claim 4, wherein the container is configured with a read-only file system.

6. The method of claim 4, wherein the container is initiated with a sandboxing mechanism that intercepts application system calls made by the container.

7. The method of claim 1, wherein the isolated computing environment comprises a virtual machine.

8. The method of claim 1, wherein causing the data to be entered as the command further comprises:
providing the data to the second CLI of the isolated computing environment.

9. The method of claim 8, further comprising executing the command within the isolated computing environment.

10. The method of claim 1, further comprising:
generating, by the isolated computing environment, information that identifies a result of causing the data to be entered as the command on the second CLI; and
providing, by the isolated computing environment to the first CLI, the information.

11. The method of claim 1, wherein outputting, to the display device, the information generated in response to the data being entered as the command further comprises:
generating a prompt that includes a first option to transfer the data to the UI text field first and a second option to not transfer the data to the UI text field; and
outputting the prompt to the display device.

12. The method of claim 11, further comprising:
receiving user input selecting the first option; and
in response to the user input, executing the paste command to transfer the data to the UI text field.

13. The method of claim 11, further comprising:
receiving user input selecting the second option; and
in response to the user input, inhibiting the paste command from transferring the data to the UI text field.

14. A computing system, comprising:
one or more computing devices operable to:
detect a paste command to transfer data to a user interface (UI) text field of a first command line interface (CLI);
inhibit the data from being transferred to the UI text field;
cause the data to be entered as a command to a second CLI of an isolated computing environment; and
output information generated in response to the data being entered as the command to the second CLI.

15. The computing system of claim 14, wherein, to detect the paste command, the one or more computing devices are further operable to detect a request to transfer the data from a clipboard, the clipboard comprising a temporary storage area for copying and pasting the data between applications.

16. The computing system of claim 14, wherein the one or more computing devices are further operable to:
subsequent to inhibiting the data from being transferred to the UI text field, initiate the isolated computing environment.

17. The computing system of claim 16, wherein the isolated computing environment comprises a container.

18. The computing system of claim 14, wherein the one or more computing devices are further operable to:
generate, by the isolated computing environment, information that identifies a result of causing the data to be entered as the command on the second CLI; and
provide, by the isolated computing environment to the first CLI, the information.

19. The computing system of claim 14, wherein to output, to the display device, the information generated in response to the data being entered as the command, the one or more computing devices are further operable to:
generate a prompt that includes a first option to transfer the data to the UI text field first and a second option to not transfer the data to the UI text field; and
output the prompt to the display device.

20. A non-transitory computer-readable storage medium that stores executable instructions to cause one or more computing devices to:
detect a paste command to transfer data to a user interface (UI) text field of a first command line interface (CLI);
inhibit the data from being transferred to the UI text field;
cause the data to be entered as a command to a second CLI of an isolated computing environment; and
output information generated in response to the data being entered as the command to the second CLI.
